(19) United States
(12) Patent Application Publication
(10) Pub. No.: US 2004/0163942 A1
(43) Pub. Date: Aug. 26, 2004

(54) Method for generating electric power and electric battery

(75) Inventors: Tomoko Yoshida, Nagoya City (JP); Tetsuo Tanabe, Nagoya City (JP)

Correspondence Address: OLIFF & BERRIDGE, PLC, P.O. BOX 19928, ALEXANDRIA, VA, 22320, US

(73) Assignee: NAGOYA UNIVERSITY, Nagoya City (JP)

(21) Appl. No.: 10/727,557

(22) Filed: Dec. 5, 2003

(30) Foreign Application Priority Data
Dec. 13, 2002 (JP) 2002-362,541

(51) Int. Cl. H02J 7/00

(52) U.S. Cl. 204/157.15; 204/193

(57) ABSTRACT

A plurality of metallic plates are arranged alternately so that the main surface of one of the metallic plates is faced to the main surface of the adjacent one of the metallic plates. The metallic plates are classified into two kinds of plates with different thicknesses. Then, energy beams are irradiated perpendicularly onto the main surfaces of the metallic plates to generate an electric energy by interactions between the energy beams and the metallic plates.

### BACKGROUND OF THE INVENTION

1. Field of the Invention

This invention relates to a method for generating electric power and an electric battery which are usable in energy industrial field, space technology industrial field and atomic power field.

2. Description of the Related Art

Much attention is paid to a solar battery which converts optical energy into electric energy, so that demand of new electric energy generating means is increased for the solar battery. Since the solar battery can be made only of semiconductor material such as Si, CdS or GaAs, however, the energy conversion efficiency of the solar battery depends on the purity of the semiconductor material and the manufacturing process (film-forming condition and film junction condition) thereof. As a result, the solar battery has difficulty in controlling the performance. Moreover, the electric conversion efficiency of the solar battery is not developed sufficiently, so that the solar battery requires large optical energy absorption area in order to generate sufficient electric power. As a result, the cost in manufacture of the solar battery is increased.

In addition, it may be that the solar battery can not supply the electric power sufficiently because the intensity of sunlight as the energy source for the solar battery depends largely on time zone (day and night) and weather.

### SUMMARY OF THE INVENTION

It is an object of the present invention, in this point of view, to provide a new method for generating electric power and a new electric battery utilizing the generating method of electric power, whereby electric energy can be generated high efficiently in low cost.

For achieving the above object, this invention relates to a method for generating electric power, comprising the steps of:

preparing a metallic solid substance, and

irradiating an energy beam onto the metallic solid substance to generate an electric energy from an interaction between the energy beam and the metallic solid substance.

Also, this invention relates to an electric battery comprising:

a metallic solid substance, and

an energy source to discharge an energy beam onto the metallic solid substance to generate an electric energy from an interaction between the energy beam and the metallic solid substance.

In view of energy problem and environment problem at present and in future, it is desired to develop an electric power-generating system which does not create and discharge harmful substance such as Co₂, NOx and Sox. In view of cost in manufacture and the above-mentioned problems relating to the solar battery, it is extremely valid to utilize radiation from radioactive waste or from cosmic space. Therefore, the inventors had intensely studied to develop a new method for generating electric power and a new electric battery utilizing the generating method of electric power from the above-mentioned viewpoints.

In the generating method of electric power and the electric battery of the present invention, when an energy beam as a radiation is irradiated onto a metallic solid substance, an interaction (Compton scattering and photoelectric effect) is generated between the energy beam and the metallic solid substance to generate secondary electrons in the metallic solid substance. Then, since the secondary electrons are ejected outside from the metallic solid substance, electron deficiencies are created in the metallic solid substance. Therefore, when the metallic solid substance is incorporated in a metallic member or an electric circuit, an electric energy can be generated from the electromotive force of the electric deficiencies of the metallic solid substance.

The efficiency in generation of the electric energy depends on the sort of material, the number of member and the configuration of the metallic solid substance. In the present invention, therefore, the electric energy can be generated easily by controlling the above-mentioned parameters. If a radiation from a radioactive waste is employed as the energy source, the electric battery can have longer operating life and can be maintenance free.

### BRIEF DESCRIPTION OF THE DRAWINGS

For better understanding of the present invention, reference is made to the attached drawings, wherein

FIG. 1 is a structural view showing an electric battery according to the present invention,

FIG. 2 is a structural view showing another electric battery according to the present invention, and

FIG. 3 is a structural view showing still another electric battery which is modified from the one shown in FIG. 2.

### DESCRIPTION OF THE PREFERRED EMBODIMENTS

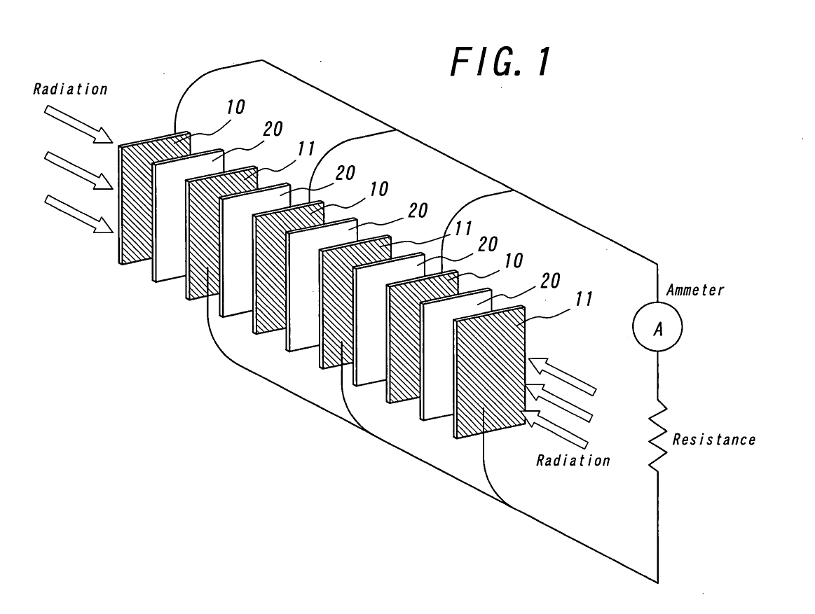

This invention will be described in detail with reference to the accompanying drawings. FIG. 1 is a structural view showing an electric battery according to the present invention. In the electric battery shown in FIG. 1, metallic plates 10 and 11 are arranged alternately so that the main surface of each metallic plate 10 is faced to the main surface of each metallic plate 11. The thickness of the metallic plate 10 is different from the thickness of metallic plate 11. In addition, insulating plates 20 are disposed between the adjacent metallic plates 10 and 11 so that the main surface of each insulating plate is faced to the main surface of each metallic plate 10 or 11. Conducting wires are connected to the metallic plates 10 and 11 so that electric currents, which are generated from electromotive forces of the metallic plates 10 and 11, are measured with an ammeter.

In the electric battery, radiations with predetermined intensities are irradiated onto the metallic plates 10 and 11 from a given radiation source (not shown) along the arrows depicted in the figure, for example, so that the irradiation directions of the radiations are almost perpendicular to the main surfaces of the metallic plates 10 and 11. In this case, secondary electrons are generated in the metallic plates 10 and 11 originated from the interactions (Compton scatterings and photoelectric effect) between the radiations and the metallic plates, and some of the secondary electrons are ejected outside from the metallic plates 10 and 11. Therefore, electromotive forces are generated in the metallic plates 10 and 11, respectively, originated from the electron deficiencies. In addition, since the thickness of the metallic plate 10 is different from the thickness of the metallic plate 11, the electromotive force of the metallic plate 10 is different from the electromotive force of the metallic plate 11. As a result, a difference in electromotive force is generated between the adjacent metallic plates 10 and 11, and thus, an electric current is generated therebetween through the conducting wires.

The electromotive forces of the metallic plates 10 and 11 depend on the irradiation areas of radiation thereof, in addition to the thicknesses of the metallic plates 10 and 11. Moreover, in this embodiment, since the metallic plates 10 and 11 are arranged plurally, the electromotive forces of the metallic plates 10 and 11 also depend on the arrangement number and the arrangement distance of the metallic plates 10 and 11. In addition, the electromotive forces of the metallic plates 10 and 11 depend on the materials constituting the metallic plates 10 and 11. By controlling these parameters, therefore, the total electro-motive force and thus, the electric current of the electric battery can be adjusted.

Generally, the electromotive force (electric current) of each metallic plate is increased with increase of the plate area irradiated by radiation. Moreover, the total electromotive force (electric current) of the electric battery is increased as the arrangement number of metallic plate is increased.

In this embodiment, since the insulating plates 20 are disposed between the adjacent metallic plates 10 and 11, the secondary electrons ejected from one of the metallic plates can not affect on the adjacent metallic plate, so that the electric power-generating operation can be performed under good condition.

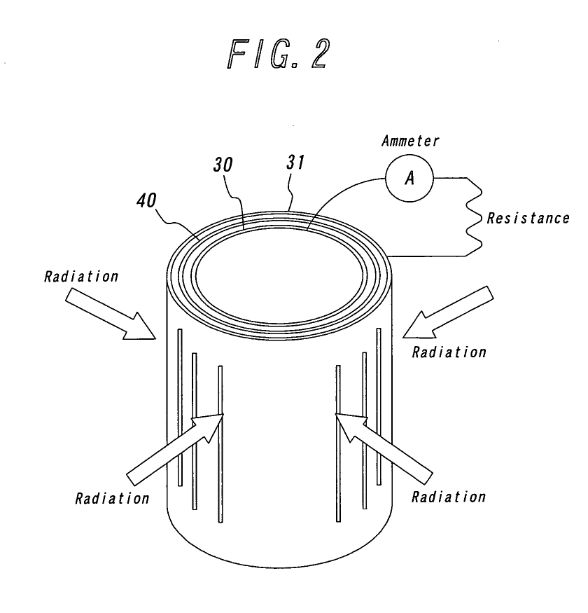

FIG. 2 is a structural view showing another electric battery according to the present invention. In the electric battery shown in FIG. 2, rolled metallic plates 30 and 31 are arranged concentrically. The thickness of each metallic plate is different from one another. A rolled insulating plate 40 is disposed between the metallic plates 30 and 31 concentrically. Conducting wires are connected to the metallic plates 30 and 31 so that electric currents, which are generated from electromotive forces of the metallic plates 30 and 31, are measured with an ammeter.

In the electric battery, radiations with predetermined intensities are irradiated onto the sides of the metallic plates 30 and 31 from a given radiation source (not shown) along the arrows depicted in the figure. In this case, secondary electrons are generated in the metallic plates 30 and 31 originated from the interactions (Compton scatterings and photoelectric effect) between the radiations and the metallic plates, and some of the secondary electrons are ejected outside from the metallic plates 30 and 31. Therefore, electromotive forces are generated in the metallic plates 30 and 31, respectively, originated from the electron deficiencies of the discharged secondary electrons. In addition, since the thickness of the metallic plate 30 is different from the thickness of the metallic plate 31, the electromotive force of the metallic plate 30 is different from the electromotive force of the metallic plate 31. As a result, a difference in electromotive force is generated between the metallic plates 30 and 31, and thus, an electric current is generated therebetween through the conducting wires.

The electromotive forces of the metallic plates 30 and 31 depend on the irradiation areas of radiation thereof, in addition to the thicknesses of the metallic plates 30 and 31. Moreover, the electromotive forces of the metallic plates 30 and 31 depend on the materials constituting the metallic plates 30 and 31. Then, the total electromotive force of the electric battery depends on the arrangement number of metallic plate and the arrangement distance of metallic plate. By controlling these parameters, therefore, the total electromotive force and thus, the electric current of the electric battery can be adjusted.

Generally, the electromotive force (electric current) of each metallic plate is increased with increase of the plate area irradiated by radiation. Moreover, the total electromotive force (electric current) of the electric battery is increased as the arrangement number of metallic plate is increased.

In this embodiment, since the insulating plate 40 is disposed between the metallic plates 30 and 31, the secondary electrons ejected from one of the metallic plates can not affect on the other metallic plate, so that the electric power-generating operation can be performed under good condition.

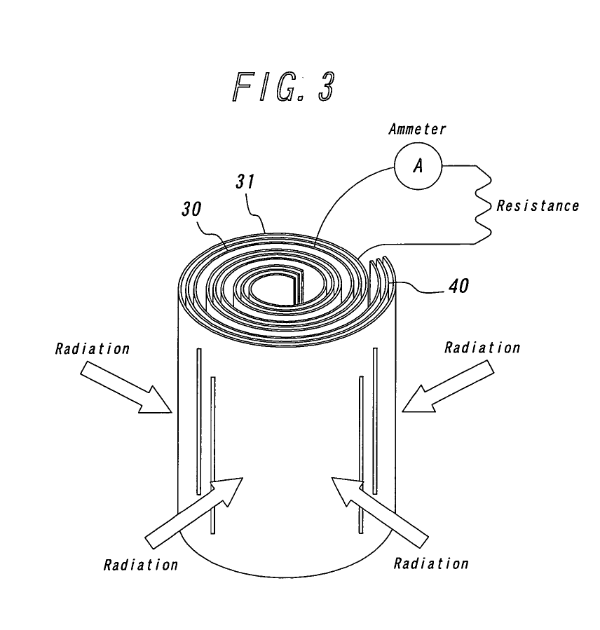

FIG. 3 is a structural view showing still another electric battery which is modified from the one shown in FIG. 2. In the electric battery shown in FIG. 3, the metallic plates 30 and 31 are rolled vertically, and the insulating plate 40 is disposed between the metallic plates 30 and 31. In this case, the end of the electric battery is opened in the rolling direction. In the electric battery, too, as mentioned in the above-mentioned embodiment relating to FIG. 2, radiations with predetermined intensities are irradiated onto the sides of the metallic plates 30 and 31 from a given radiation source (not shown) along the arrows depicted in the figure, and an electric current is generated therebetween through the conducting wires, originated from the difference in electromotive force between the metallic plates 30 and 31.

The electromotive forces of the metallic plates 30 and 31 depend on the irradiation areas of radiation thereof, in addition to the thicknesses of the metallic plates 30 and 31. Moreover, the electromotive forces of the metallic plates 30 and 31 depend on the materials constituting the metallic plates 30 and 31. Then, the total electromotive force of the electric battery depends on the arrangement number of metallic plate and the arrangement distance of metallic plate. By controlling these parameters, therefore, the total electromotive force and thus, the electric current of the electric battery can be adjusted.

In the above-mentioned embodiments, the radiations are employed as energy beams are irradiated onto the metallic plates. The radiation means α-ray, β-ray, Γ-ray and X-ray. The radiations may be generated from radioactive waste. In this case, the radioactive waste can be utilized effectively, which is desired in view of effective utilization of earth resources. Moreover, since the radioactive waste can be employed semi-permanently, the electric battery can have longer operating life and can be maintenance free.

In these embodiments, although the radiation is employed as the energy beam, another energy beam such as electron beam, electromagnetic wave or laser beam may be employed.

### EXAMPLES

### Example 1

In this example, 12 first stainless plates and 12 second stainless plates were prepared. The thickness, the length and the width of the first stainless plate were set to 1 mm, 5 cm and 10 cm, respectively. The thickness, the length and the width of the second stainless plate were set to 0.1 mm, 5 cm and 10 cm, respectively. The first and the second stainless plates were arranged alternately, and 12 insulating copy papers were disposed between the adjacent first and second stainless plates, respectively, to form an electric battery as shown in FIG. 1. Then, Γ rays (about 1.45 Gy/sec) were irradiated perpendicularly onto the main surfaces of the stainless plates from a cobalt 60 irradiation device under room temperature.

In this case, a current of about 3 nA was measured with an ammeter. Herein, the measurement background noise was 3 pA or below.

### Example 2

In this example, two stainless foils were prepared. One has a thickness of 0.1 mm and a width of 10 cm, and the other has a thickness of 0.01 mm and a width of 10 cm. The stainless foils were rolled concentrically, and an insulating copy paper was disposed between the stainless foils, to form an electric battery as shown in FIG. 2. Then, Γ rays (about 1.45 Gy/sec) were irradiated onto the sides of the stainless foils from a cobalt 60 irradiation device under room temperature. In this case, a current of about 15 nA was measured with an ammeter.

### Example 3

In this example, two stainless foils were prepared. One has a thickness of 0.1 mm and a width of 10 cm, and the other has a thickness of 0.01 mm and a width of 10 cm. The stainless foils were rolled vortically by 34 turns, and an insulating copy paper was disposed between the stainless foils, to form an electric battery as shown in FIG. 3. Then, Γ rays (about 1.45 Gy/sec) were irradiated onto the sides of the stainless foils from a cobalt 60 irradiation device under room temperature. In this case, a current of about 100 nA was measured with an ammeter.

Although the present invention was described in detail with reference to the above examples, this invention is not limited to the above disclosure and every kind of variation and modification may be made without departing from the scope of the present invention.

Although in the above-mentioned embodiments, two kinds of metallic plates or metallic foils with the respective different thicknesses are employed and the resultant different electromotive forces from the plates or the foils are utilized, one kind of plate or foil may be employed and a given electromotive force from the plate or the foil can be utilized directly. Moreover, metallic solid substances made by solidifying powdery raw material may be employed, instead of the metallic plates and the metallic foils.

As mentioned above, the present invention can provide a new method for generating electric power and a new electric battery, whereby electric energy can be generated at high efficiently in low cost.

What is claimed is:

1. A method for generating electric power, comprising the steps of:
preparing a metallic solid substance, and
irradiating an energy beam onto said metallic solid substance to generate an electric energy from an interaction between said energy beam and said metallic solid substance.

2. The generating method as defined in claim 1, wherein said metallic solid substance is a metallic plate.

3. The generating method as defined in claim 2, further comprising the step of controlling the irradiation area of said metallic plate for said energy beam to adjust the efficiency in generation of said electric energy.

4. The generating method as defined in claim 2, further comprising the step of controlling the thickness of said metallic plate to adjust the efficiency in generation of said electric energy.

5. A method for generating electric power, comprising the steps of:
preparing a plurality of metallic plates,
arranging said metallic plates so that the main surface of one of said metallic plates is faced to the main surface of the adjacent one of said metallic plates, and
irradiating energy beams onto said metallic plates to generate an electric energy from interactions between said energy beams and said metallic plates.

6. The generating method as defined in claim 5, further comprising the step of disposing insulating substances between adjacent ones of said metallic plates, respectively.

7. The generating method as defined in claim 5, further comprising the step of controlling the arrangement number of said metallic plates to adjust the efficiency in generation of said electric energy.

8. The generating method as defined in claim 5, further comprising the step of controlling the arrangement distance of said metallic plates to adjust the efficiency in generation of said electric energy.

9. The generating method as defined in claim 5, further comprising the step of controlling the irradiation areas of said metallic plates for said energy beams to adjust the efficiency in generation of said electric energy.

10. The generating method as defined in claim 5, further comprising the step of controlling the thicknesses of said metallic plates to adjust the efficiency in generation of said electric energy.

11. The generating method as defined in claim 1, wherein said metallic solid substance is a rolled metallic plate.

12. The generating method as defined in claim 11, further comprising the step of controlling the irradiation area of said rolled metallic plate for said energy beam to adjust the efficiency in generation of said electric energy.

13. The generating method as defined in claim 11, further comprising the step of controlling the thickness of said rolled metallic plate to adjust the efficiency in generation of said electric energy.

14. A method for generating electric power, comprising the steps of:
preparing a plurality of rolled metallic plates,
arranging said rolled metallic plates concentrically, and
irradiating energy beams onto said rolled metallic plates to generate an electric energy from interactions between said energy beams and said rolled metallic plates.

15. The generating method as defined in claim 14, further comprising the step of disposing insulating substances between adjacent ones of said solid rolled metallic plates, respectively.

16. The generating method as defined in claim 14, further comprising the step of controlling the arrangement number of said rolled metallic plates to adjust the efficiency in generation of said electric energy.

17. The generating method as defined in claim 14, further comprising the step of controlling the arrangement distance of said rolled metallic plates to adjust the efficiency in generation of said electric energy.

18. The generating method as defined in claim 14, further comprising the step of controlling the irradiation areas of said rolled metallic plates for said energy beams to adjust the efficiency in generation of said electric energy.

19. The generating method as defined in claim 14, further comprising the step of controlling the thicknesses of said rolled metallic plates to adjust the efficiency in generation of said electric energy.

20. The generating method as defined in claim 1, wherein said metallic solid substance is stainless steel.

21. The generating method as defined in claim 1, wherein said energy beam is a radiation.

22. The generating method as defined in claim 21, wherein said radiation is released from a radioactive waste.

23. An electric battery comprising:
a metallic solid substance, and
an energy source to release an energy beam onto said metallic solid substance to generate an electric energy by an interaction between said energy beam and said metallic solid substance.

24. The electric battery as defined in claim 23, wherein said metallic solid substance is a metallic plate.

25. An electric battery comprising:
a plurality of metallic plates, and
an energy source to release energy beams perpendicularly onto the main surfaces of said metallic plates to generate an electric energy by interactions between said energy beams and said metallic plates.

26. The electric battery as defined in claim 25, further comprising a plurality of insulating substances disposed between said metallic plates, respectively.

27. The electric battery as defined in claim 23, wherein said metallic solid substance is a rolled metallic plate.

28. An electric battery comprising:
a plurality of rolled metallic plates, and
an energy source to release energy beams onto the sides of said rolled metallic plates to generate an electric energy by interactions between said energy beams and said rolled metallic plates.

29. The electric battery as defined in claim 28, further comprising an insulating substance disposed between said rolled metallic plates.

30. The electric battery as defined in claim 23, wherein said metallic solid substance is made of stainless steel.

31. The electric battery as defined in claim 23, wherein said energy source comprises a radioactive waste.
